(19) United States
(12) Patent Application Publication
(10) Pub. No.: US 2008/0307134 A1
(43) Pub. Date: Dec. 11, 2008

(54) I2C bus interface and protocol for thermal and power management support

(76) Inventors: Andrew J. Geissler, Pflugerville, TX (US); Michael C. Hollinger, Austin, TX (US); Martha A. Broyles, Austin, TX (US); Todd J. Rosedahl, Zumbrota, MN (US); Hye-Young McCreary, Liberty Hill, TX (US); Andreas Bieswanger, Ehningen (DE)

Correspondence Address: HAMILTON & TERRILE, LLP;IBM Austin, P.O. BOX 203518, AUSTIN, TX, 78720, US

(21) Appl. No.: 11/758,158

(22) Filed: Jun. 5, 2007

(51) Int. Cl. G06F 13/00

(52) U.S. Cl. 710/110

(57) ABSTRACT

A method, apparatus and computer instructions are provided for controlling communications between controller devices over an I²C bus hardware interface and a separate communication line, such as a GPIO line. With thermal/power management firmware installed on a system controller device, communications between the system controller device and a real time embedded controller device are sent using a predefined protocol whereby the system controller generates commands to the embedded controller by first performing an I²C write with a command packet, followed immediately thereafter by an I²C read to get the return packet. The embedded controller processes the command and returns the response to the I²C read. In addition, the embedded controller is able to make the system controller aware that it has a communication request by interrupting the system controller by asserting the separate communication line, in response to which the system controller issues a status request command to the embedded controller.

### BACKGROUND OF THE INVENTION

1. Field of the Invention

The present invention is directed in general to an improved data processing system. In one aspect, the present invention relates to a real time communication interface and protocol that may be used to support thermal and power management in a data processing system.

2. Description of the Related Art

Data processing systems are increasingly required to manage power and/or thermal conditions, especially with today's server systems. As the number of processors in the data processing system continues to increase, the power consumed and wattage/heat dissipated by most of these processor chips also increase. The cooling of high frequency or high performance processors also becomes a challenge.

Typically, designers attempt to optimize the thermal or power performance of a data processing system by adjusting specific system characteristics, including increasing or decreasing performance, acoustics and power dissipation. In addition, depending on the customer need, one or more of the system characteristics may be optimized at the expense of another. For example, if the ambient temperature is cool or if the customer can ignore increased acoustics, the fan speed may be increased to cool the processors, such that the processors may run at a higher frequency to achieve a better performance. To this end, an embedded controller device may be included in the data processing system to monitor and control the power and thermal characteristics of the system. The embedded controller device may include hardwired logic or equivalent firmware functionality which gathers data from one or more power and/or thermal sensors in the system, and generates therefrom actuation signals that are used to control or throttle the system performance. Where the real time requirements for monitoring and controlling the power and thermal characteristics of the system consume most of the processing bandwidth of the embedded controller device, a separate controller (e.g., a system controller) may be used to handle other power/thermal processing requirements, such as receiving power management input from the customer, collecting system characterization data, etc. However, because the real time control requirements for the embedded controller device limit the amount of processing bandwidth that is available for communicating with the system controller, there are significant limits on the ability of the embedded controller device to communicate with the system controller and obtain the benefit of the additional power/thermal processing being performed on the system controller. While there are communication protocols, such as the Inter-IC Bus (hereinafter the “I²C Bus”) protocol, that could be used for communicating between different controller devices, there are certain limits to such protocols that limit their usefulness here. For example, if a device (e.g., an embedded controller) is configured as a bus slave, there is no mechanism provided for the slave to request a communication with the master (e.g., the system controller). Additional deficiencies with the I²C protocol include the absence of detailed error recovery support (which can be useful when there is a firmware failure or a hardware measurement/actuation failure, or a failure to contain the power/thermal cap), the unlimited size of interface messages (which can consume processor bandwidth at the embedded controller), and the absence of an effective mechanism for determining if the slave device is up and running.

Therefore, it would be advantageous to have a method, an apparatus, and computer instructions for establishing an efficient communication interface and protocol between the embedded and system controllers that allows for information to be efficiently exchanged, even when there is limited processing bandwidth available on the embedded controller device. In this way, monitoring and adjustment of system characteristics may be centralized at a system controller and communications between hardware and system firmware may be increased to achieve policy-based customer goals. In addition, there is a need for a firmware and hardware protocol to communicate over a standard hardware interface. There is also a need for an efficient communication interface which provides detailed error recovery support along with a mechanism for determining if firmware on one of the devices is up and running. Further limitations and disadvantages of conventional installation/configuration processing solutions will become apparent to one of skill in the art after reviewing the remainder of the present application with reference to the drawings and detailed description which follow.

### SUMMARY OF THE INVENTION

A system and methodology are provided for managing communications between two devices using the I²C bus hardware interface. To communicate over the I²C, a protocol is provided whereby the first device (e.g., a system controller) is the master of the I²C bus, and the second device (e.g., an embedded controller) supports the I²C slave interface. The protocol provides further that the slave/embedded controller includes a mechanism for requesting a communication with the master/system controller, such as by asserting a GPIO pin. In accordance with selected embodiments, the protocol further specifies a detailed error recovery scheme, and limits the size of interface messages exchanged between the slave/embedded controller and the master/system controller to a predetermined size limit by breaking up messages that exceed the predetermined size limit. The protocol may further specify a heartbeat interface whereby the master/system controller can ascertain whether firmware on the slave/embedded controller is up and running.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary diagram of a distributed data processing system in which the present invention may be implemented;

FIG. 2 depicts an exemplary architectural diagram of a server data processing system in which the present invention may be implemented;

FIG. 3 depicts an exemplary architectural diagram of a client data processing system in which the present invention may be implemented;

FIG. 4 is a diagram illustrating components for a thermal and power management system in which various embodiments of the present invention may be implemented;

FIG. 5 depicts an example protocol flow to illustrate how a system controller generates commands to an embedded controller; and

FIG. 6 depicts an example protocol flow to illustrate how an embedded controller generates a communication request to a system controller.

### DETAILED DESCRIPTION

In accordance with various embodiments, a system, methodology and program are disclosed for controlling communications between firmware and hardware over an I²C bus hardware interface. For example, if the firmware is a thermal/power management firmware installed on a system controller device, communications between the system controller device and a real time embedded hardware or controller device are sent over I²C bus using a predefined protocol. Under the predefined protocol, the system controller device is the master of the I²C bus and the embedded device supports the I²C slave interface. In this way, the system controller can generate commands to the embedded device by first performing an I²C write with a command packet, followed immediately thereafter by an I²C read to get the return packet. The embedded device will process the command and return the response to the I²C read. In addition, the embedded device is able to make the system controller aware that it has a communication request by interrupting the system controller via a GPIO pin request. When the system controller is ready to process the communication request from the embedded device, the system controller sends a poll command to the embedded device, and waits for a predetermined timeout interval for a response by the embedded device. The protocol may also provide for error recovery support when there is a firmware failure or a hardware measurement/actuation failure, or a failure to contain the power/thermal cap. In addition, the protocol controls or limits the size of commands to break up the data that exceeds a predetermined size limit.

Various illustrative embodiments of the present invention will now be described in detail with reference to the accompanying figures. It will be understood that the flowchart illustrations and/or block diagrams described herein can be implemented in whole or in part by dedicated hardware circuits, firmware and/or computer program instructions which are provided to a processor of a general purpose computer, special purpose computer, or other programmable data processing apparatus to produce a machine, such that the instructions (which execute via the processor of the computer or other programmable data processing apparatus) implement the functions/acts specified in the flowchart and/or block diagram block or blocks. In addition, while various details are set forth in the following description, it will be appreciated that the present invention may be practiced without these specific details, and that numerous implementation-specific decisions may be made to the invention described herein to achieve the device designer's specific goals, such as compliance with technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. In addition, some portions of the detailed descriptions provided herein are presented in terms of algorithms or operations on data within a computer memory. Such descriptions and representations are used by those skilled in the art to describe and convey the substance of their work to others skilled in the art.

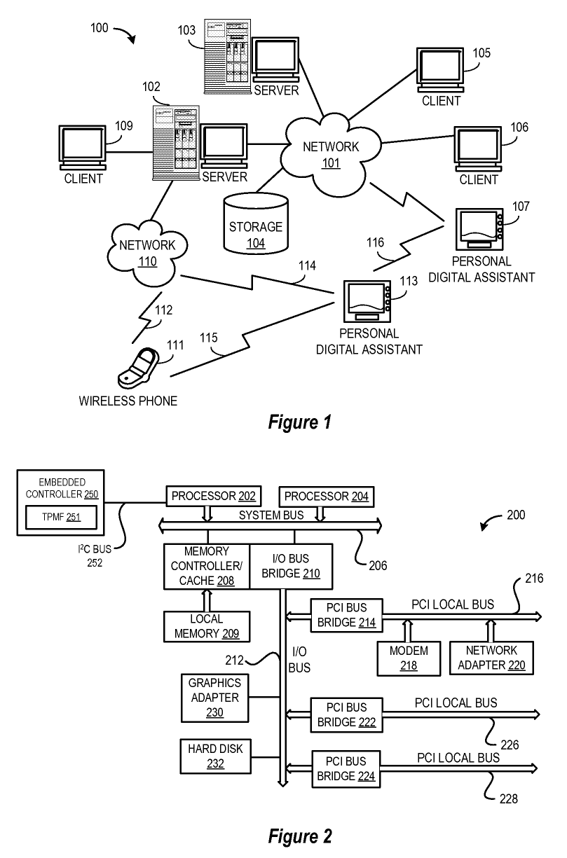

With reference now to the figures, FIG. 1 depicts a distributed data processing system 100 in which the present invention may be implemented. The distributed data processing system 100 includes a network 101, which is a medium that may be used to provide communications links between various devices and computers connected together within distributed data processing system 100. The network 101 may include permanent connections, such as wire or fiber optic cables, or temporary connections made through telephone or wireless communications. In the depicted example, the network 101 may be implemented in whole or in part with a worldwide collection of networks and gateways (e.g., the Internet) that use various protocols to communicate with one another, such as LDAP (Lightweight Directory Access Protocol), TCP/IP (Transport Control Protocol/Internet Protocol), HTTP (HyperText Transport Protocol), etc. Of course, the distributed data processing system 100 may also include a number of different types of networks, such as, for example, an intranet, a local area network (LAN), or a wide area network (WAN). For example, server 102 directly supports client 109 and network 110, which incorporates wireless communication links 112, 114 for connecting to a network-enabled phone 111 and PDA 113, respectively. In turn, wireless phone 111 and PDA 113 can also directly transfer data between themselves across wireless link 115 using an appropriate technology, such as Bluetooth™ wireless technology, to create so-called personal area networks or personal ad-hoc networks. In a similar manner, PDA 113 can transfer data to PDA 107 via wireless communication link 116. FIG. 1 also shows that server 102 and server 103 are connected to the network 101 along with storage unit 104. In addition, clients 105-107 may be connected to the network 101. The clients 105-107 and servers 102-103 may be represented by a variety of computing devices, such as mainframes, personal computers, personal digital assistants (PDAs), etc. The distributed data processing system 100 may include additional servers, clients, routers, other devices, and peer-to-peer architectures that are not shown. While the present invention may be implemented on a variety of hardware platforms and software environments, FIG. 1 is intended as an example of a heterogeneous computing environment and not as an architectural limitation for the present invention.

Referring now to FIG. 2, an exemplary architectural diagram is depicted of a server data processing system 200 (such as a server 102 shown in FIG. 1). Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients (e.g., 109) in FIG. 1) may be provided through modem 218 or network adapter 220 connected to PCI local bus 216 through add-in connectors. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

As indicated above, the server data processing system 200 may include one or more system processor or control devices 202, 204 for providing general purpose control functionality and/or diagnostic processing functionality. In addition, a dedicated or embedded controller 250 may be included to provide a special purpose control functionality, such as measuring and controlling the voltage, current and/or temperature characteristics of the server data processing system 200. The embedded controller 250 may be implemented with any desired combination of hardware and/or software components, and in an example embodiment, is implemented a dedicated microcontroller and external memory and skewable clock which act together to monitor and control one or more sensors and actuators on the data processing system 200 by throttling and/or powering down system components, such as CPU or memory components.

As illustrated in FIG. 2, the temperature and power management function is implemented with temperature and power management firmware (TPMF) 251 running on the embedded controller 250, which in turn is connected to a system processor/controller 202 via a dedicated communication bus 252, such as an I²C bus. The embedded controller 251 may also be connected to individual sensors and regulators on the data processing system 200 using an I²C bus for each connection. With such a configuration, the embedded controller receives data from one or more sensors (not shown) to determine workload characteristics of the server data processing system 200, and then uses one or more actuator devices (e.g., voltage regulators, frequency actuators, etc.) to control the power and thermal characteristics of the server data processing system 200. To allow the processing bandwidth of the embedded controller 250 to be used for its dedicated control functionality, selected management functions are off-loaded to the system processor/controller 202. For example, the system processor/controller 202 may provide a control functionality which allows a user to control the power management behavior of the data processing system 200 using configurable policies, such as by setting the operational power level or performance level for the data processing system 200. To maintain real-time control over the system performance, the communication bus 252 may be implemented as an I²C bus which is an industry standard hardware interface which uses two wires (a clock line and a data line) to connect a master station and one or more slave stations.

Those of ordinary skill in the art will appreciate that the hardware used to implement the data processing system 200 can vary, depending on the system implementation. For example, the data processing system depicted in FIG. 2 may be implemented in an IBM eServer System P, a product of International Business Machines Corporation in Armonk, N.Y., running the Advanced Interactive Executive (AIX) operating system or LINUX operating system. Alternatively, the data processing system may be implemented in IBM's iSeries server, IBM's POWER6 Blade server, to provide but a few examples. As will be appreciated, various embodiments may use other hardware or peripheral devices, such as flash read-only memory (ROM), equivalent nonvolatile memory, or optical disk drives and the like, in addition to or in place of the hardware depicted in FIG. 2. In addition to being able to be implemented on a variety of hardware platforms, the present invention may be implemented in a variety of software environments so that different operating systems (such as Linux, Microsoft, AIX, BSD, Mac OS, HP-UX and Java-based runtime environments) are used to execute different program applications (such as a word processing, graphics, video, or browser program). In other words, while different hardware and software components and architectures can be used to implement different data processing systems, such hardware or architectural examples are not meant to imply limitations with respect to the bus interface and protocol disclosed herein.

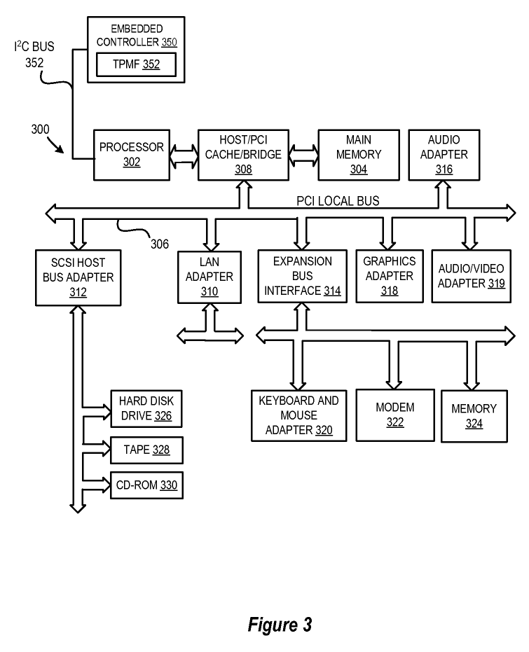

With reference now to FIG. 3, an exemplary architectural diagram illustrating a client data processing system 300 is depicted in which the present invention may be implemented. The depicted client data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. One or more processors 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within the client data processing system 300. The operating system may be a commercially available operating system, such as Windows XP, which is available from Microsoft Corporation. Instructions for the operating system, and applications or programs are located on storage devices, such as hard disk drive 326, and may be loaded into main memory 304 for execution by processor 302. Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

To provide a dedicated control function, the client data processing system 300 may include a dedicated or embedded controller 350 that is connected to a system processor/controller 302 via a dedicated communication bus 352, such as an I²C bus. For example, the embedded controller 350 may include hardware or firmware for measuring and controlling the voltage, current and/or temperature characteristics of the client data processing system 300. As illustrated in FIG. 3, the temperature and power management function is implemented with firmware (TPMF) 351 running on the embedded controller 350.

In an example embodiment, the client data processing system 300 may be a stand-alone system configured to be bootable without relying on some type of network communication interfaces. As a further example, data processing system 300 may be a notebook computer, a hand held computer, a kiosk, a Web appliance or a personal digital assistant (PDA) device, which is configured with ROM and/or flash ROM in order to provide non-volatile memory for storing operating system files and/or user-generated data. Thus, the depicted example in FIG. 3 and above-described examples are not meant to imply architectural limitations.

The present invention provides a method, an apparatus, and computer instructions for controlling communications between devices in a data processing system using hardware that is inexpensive and easy to implement by defining a robust and reliable communication protocol. In the defined protocol, commands are exchanged between devices using a predetermined format with built-in sequence numbers and with checksum and retry rules that define an error call out and recovery mechanism. The defined protocol is stream oriented to have a defined flow control, and may also provide the capability for a real time embedded controller to slow down the communication interface with a system controller when required. In addition, the protocol allows variable length responses to be exchanged between devices by breaking up interface messages that exceed a predetermined limit. Such a communication protocol may be advantageously used in a variety of applications, particularly where a robust, reliable, efficient and inexpensive communication interface is needed between devices.

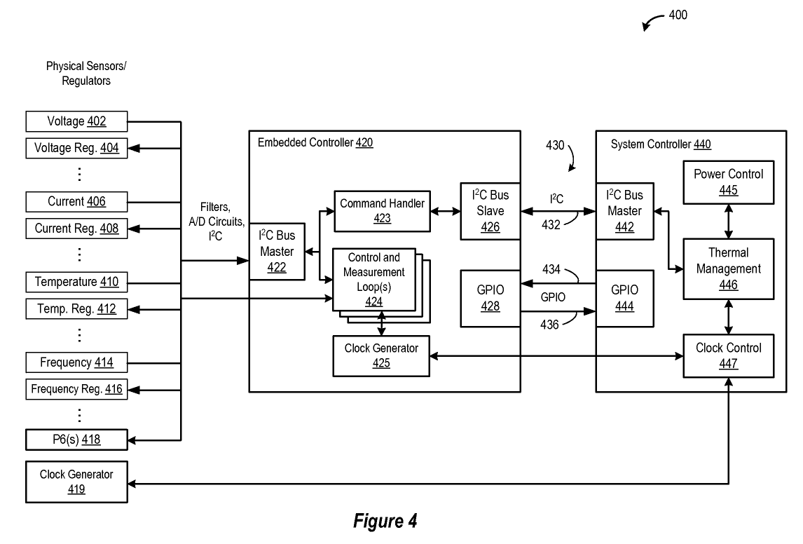

To illustrate an example of one such application, reference is now made to FIG. 4, which diagrammatically illustrates components for a thermal and power management system 400 in which various embodiments of the present invention may be implemented. In the depicted example, the thermal and power management system 400 includes a power control 445 and thermal management 446 implemented as a firmware components in a system controller 440 for optimizing different system characteristics according to customer-valued goals. The system controller 440 also includes a clock control 447 for controlling clock generators 425, 419. The power control and thermal management components 445, 446 may be computer implemented instructions executed by one or more diagnostic processors, such as the system processor 202 in FIG. 2, or the processor 302 in FIG. 3. The power control and thermal management components 445, 446 collaborate with different hardware to provide a base set of functionalities for monitoring and adjusting different system characteristics. For example, the system controller 440 communicates over the I²C communication bus 432 with an embedded controller 420 having the command handler 423. The command handler 423 reads commands from the system controller 440, calls the correct component(s) 402-419 based on that command, and returns the status to the system controller 440. The command handler 423 also provides the interface to support an interrupt to the system controller 440 via a GPIO line 436 to request an immediate poll.

Under control of the command handler, the embedded controller 420 uses one or more control and measurement loops 424 which read information from a number of sensor which measure values in a specific hardware components and from the clock generator 425. In the depicted example, a voltage sensor 402 provides measurements of voltage levels at a processor core, where the measurements are filtered and/or converted to digital form with analog-to-digital conversion (ADC) circuitry before being conveyed over a communication bus to the embedded controller 420. In similar fashion, a power supply current sensor 406 may provide measurements for power supply current, a temperature sensor 410 may provide measurements for air-inlet temperature, and a frequency sensor 414 may provide frequency data from another part of the system. Of course, other types of sensors may be connected to provide measurements to the control loop 424, either over the I²C bus or directly. When the data measurements from the sensors are conveyed over an I²C communication bus, the embedded controller 420 is configured as the I²C bus master 422, while the sensors and regulators are configured as the I²C bus slave. In addition to sensors, the embedded controller 420 also communicates over an I²C bus with one or more regulators which are used to control the thermal/power performance of the system. Examples of regulator include voltage regulator 404, current regulator 408, temperature regulator 412, processor frequency 416, and processor throttling 418, though other regulators (e.g., fan speed regulator) can be used. With this arrangement, the control and measurement loop 424 may adjust a regulator if a warning temperature is measured, and also signal to the thermal management component 446 to send a notification to notify the customer of the warning temperature.

In operation, the thermal management module 446 selects a control loop algorithm from a plurality of control loop algorithms 424 based on a customer profile or policy. Examples of control loop algorithms include performance algorithm for controlling performance, a thermal algorithm for controlling temperature, a power control loop for controlling power, and acoustics algorithm for controlling acoustics. For additional information concerning an example embodiment of the autonomic management of system characteristics, reference is made to U.S. Patent Publication No. 2006/0178764 entitled “Method and apparatus for autonomic policy-based thermal management in a data processing system,” which is incorporated herein by reference as if fully set forth herein. Based on the values measured from sensors, the selected control loop algorithm adjusts required parameters (e.g., voltage settings, processor frequency, throttling, and fan speed) for regulators to optimize system behavior. For example, the control loop algorithm 424 may adjust fan speed if a warning temperature is measured, at which time the autonomic component 446 may send a notification to notify the customer of the warning temperature.

To efficiently and reliably exchange information between the embedded controller 420 and system controller 440, a communication interface and protocol 430 are provided whereby an I²C bus 432 is used in combination with GPIO pins 434, 436 to communicatively couple the embedded controller 420 and system controller 440. In support of the I²C bus 432, the system controller 440 is configured as the I²C bus master 442, while the embedded controller 420 is configured as the I²C bus slave 426. Commands from the system controller 440 are conveyed by the I²C bus master 442 by performing an I²C write operation, followed by an I²C read operation. In this way, the response to the command generated by the embedded controller 420 is sent as a return packet in response to the I²C read operation. To support communication requests from the embedded controller 420, a GPIO pin 436 is provided which is asserted by the embedded controller 420 when requesting communication with the system controller 440.

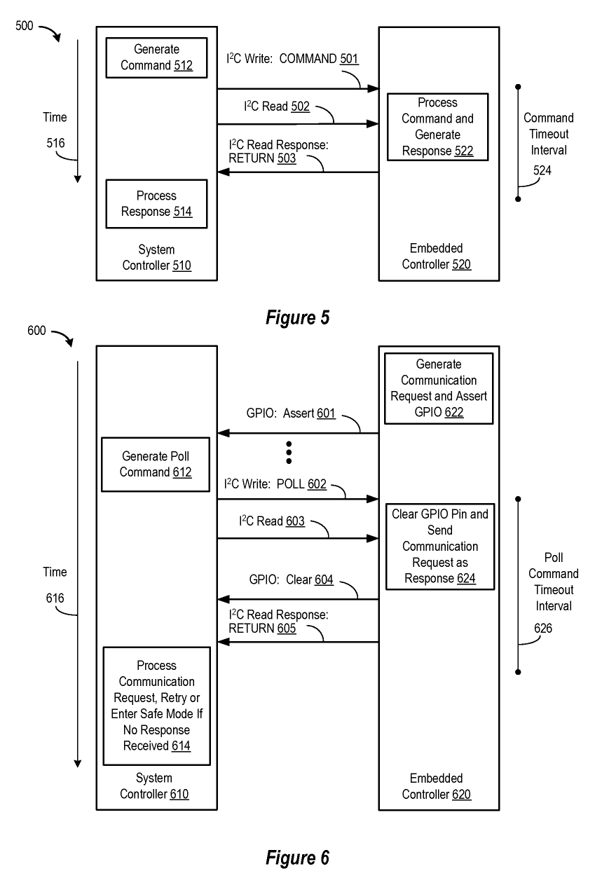

Additional details concerning the communication interface and protocol 430 are set forth in FIG. 5, which depicts an example protocol flow 500 to illustrate how a system controller 510 generates commands to an embedded controller 520. As depicted, the flow sequence proceeds in time as indicated by the down arrow 516 on the left, and begins when the system controller 510 generates one of a predetermined set of commands (512). In accordance with a predetermined protocol, each of the commands defines a specific function for the embedded controller to perform, and each command is configured in a predetermined format to specifically identify the particular function being requested. For example and as described more fully below, when the command is generated by thermal and power management firmware running on the system controller 510, the commands may include a “Poll” command (to periodically poll the embedded controller for status information), a “Query Firmware Level” command (to obtain information about the firmware on the embedded controller), a “Get Error Log” command (to obtain an error log from the embedded controller), a “Continue Error Log” command (to continue the Get Error Log command), a “Clear Error Log” command (to instruct the embedded controller to an clear error log as an acknowledgement that the system controller received the error log), a “Set Mode and State” command (to set the embedded controller state and/or system power management mode), a “Setup Configuration Data” command (to send setup configuration data to the embedded controller), a “Download Data” command (to send a block of download code to the embedded controller), a “Pass Through” command (to send a command to the embedded controller), a “Debug Pass Through” command (for use with debugging), an “Interface Test” command (to test the I²C interface to the sensor/regulators), a “Processor Interface Test” command (to test the I²C interface to the processors) and a “Set Clock Frequency” command (to set the embedded controller clock to a specified frequency).

The system controller 510 conveys the command to the embedded controller 520 by first performing an I²C write with the command packet (501), and then immediately performing an I²C read (502) to get the return packet. At the embedded controller 520, the received command is processed to generate a response (522), and the response is returned to the system controller 510 in response to the I²C read (503). The system controller 510 may then process the response as appropriate (514). As indicated by the down arrow 524 on the right, each command has a predefined timeout interval 524 within which the response must be returned by the embedded controller 520. If the embedded controller 520 does not respond to the command within the timeout interval, the system controller 510 may retry the command one or more times, but if no response is returned from the embedded controller 520 upon retry, the system controller logs an error and goes into safe mode.

FIG. 6 depicts an example protocol flow 600 to illustrate how an embedded controller 620 generates a communication request to a system controller 610. As with FIG. 5, the flow sequence 600 proceeds in time as indicated by the down arrow 616 on the left, and begins when the embedded controller 620 generates a communication request (622). To make the system controller 610 aware that the embedded controller 620 has a communication request, the embedded controller uses the GPIO pin (601) to issue an interrupt to the system controller 610, such as by asserting the GPIO pin (622). As indicated by the dotted line below the GPIO assert signal (601), an assertion of the GPIO pin does not guarantee that the next command from system controller 610 will be in response to the GPIO assertion. For example, the system controller 610 may send what it considers to be a higher priority request to which the embedded controller 620 must respond. However, when system controller 610 is ready to process the embedded controller communication request, the system controller 610 generates a predetermined command (e.g., a Poll command) (612) which is sent over the I²C bus to the embedded controller 620, again by performing an I²C write with the command packet (602), and then immediately performing an I²C read (603) to get the return packet. In response to receiving the Poll command (602), the embedded controller clears the GPIO pin (604) and sends the communication request (624) over the I²C bus by including the communication request in the return packet (605) within the poll command timeout interval 626. It will be appreciated that the sequence of clearing the GPIO (604) and returning the communication request (605) can be reversed, though in selected embodiments, the system controller 610 will only process an interrupt when the GPIO is asserted (e.g., goes from OFF to ON), in which case the embedded controller 620 must clear the GPIO pin in order to interrupt the system controller 610 again. In any event, when the system controller 610 receives the communication request (605) over the I²C bus, the request is processed, but if no response is returned from the embedded controller 620 upon retry, the system controller logs an error and goes into safe mode (614).

As indicated above, the interface and protocol for exchanging information between the system controller and embedded controller may be defined with reference to a exchanging a predetermined set of commands and responses over a communication interface. While the commands may use any a predetermined format to specifically identify the particular function being requested, the following description is provided to illustrate an example formatting protocol for one or commands that may be used to transport commands and responses across an I²C bus as part of a thermal and power management system. In the example formatting protocol, each command packet is formatted as a series of fields, bytes or portions to include a sequence number portion (to identify the command in a sequence of commands), a command type portion (to identify the type of command), one or more data length portions (to identify the length of the command data), one or more data portions (containing the command data), and one or more checksum portions (for performing error detection on the command packet). In addition, for each command packet, there is a return packet that is formatted as a series of fields, bytes or portions to include a sequence number portion (which is the same as the sequence number for the corresponding command), a command type portion (to identify the type of command the return packet is for), a return status portion (to indicate the success or failure of the command), one or more data length portions (to identify the length of the return data), one or more data portions (containing the return data), and one or more checksum portions (for performing error detection on the return packet).

One example command is the “Poll” command which may be used by the system controller to periodically poll the embedded controller for status information. The Poll command may also be used as a heartbeat interface to make sure the embedded controller is functional (i.e., up and running). In addition, the Poll command may be used in response to receiving an interrupt from the embedded controller, such as by asserting the GPIO pin when the embedded controller is requesting to send a communication request to the system controller. With the Poll command, the command type portion identifies the command as a Poll command, and the command data (e.g., a single byte of data) may be used to identify what type or version of poll response is being requested.

In response to the Poll command, a Poll return packet may be generated having the same sequence number and command type values. The Poll return packet may also include a return code in the return status portion to indicate whether the Poll command succeeded. For example, a first return code may indicated that the command was accepted and processed by the embedded controller, while a second return code may provide a Conditional Success indication when the command was accepted and processed by the embedded controller but there is more processing required. Additional return codes may indicate that the command was not successful by specifying an error that occurred, such as an invalid command error (when a command type is invalid), an invalid command length error (when the command data length is invalid for a particular command), an invalid data field error (command data has an invalid value for a field), a checksum failure error (when the command packet checksum is not correct), an internal error (when an error occurred within the embedded controller to prevent the command from being processed) or a state error (when an embedded controller state prohibits certain commands from being accepted). In addition, the return data included in the Poll return packet provides status information for the embedded controller using one or more data bytes. For example, a first status byte provides general status information for the embedded controller, where individual bits in the first status byte indicate, for example, (1) whether the embedded controller is in a download state and ready to receive a “Download Data” command, (2) whether the embedded controller is running boot code, (3) whether the embedded controller is running boot loader, (4) whether the embedded controller is ready to be placed in an observation state, and (5) whether the embedded controller is in an active state so that it is ready to take over and control. A second status byte provides an indication of what configuration data is needed by the embedded controller. A third status byte provides an indication of the current state of the embedded controller using a predetermined set of state codes. A fourth status byte identifies the current system power management mode. A fifth status byte identifies a new system power management mode being requested by the embedded controller. A sixth status byte identifies a new embedded controller state being requested by the embedded controller. A seventh status byte identifies a log id associated with an error log for the embedded controller.

Another example command is the “Query Firmware Level” command which may be used by the system controller to obtain information about the firmware on the embedded controller. With the Query Firmware Level command, the command type portion identifies the command as a Query Firmware Level command, and there is no need for any command data. In response to the Query Firmware Level command, a Query Firmware Level return packet may be generated having the same sequence number and command type values. The Query Firmware Level return packet may also include a return code in the return status portion to indicate whether the Query Firmware Level command succeeded. In addition, the return data included in the Query Firmware Level return packet provides information identifying the firmware level currently running on the embedded controller.

The “Get Error Log” command is another example command which may be used by the system controller to obtain an error log from the embedded controller. The system controller uses the error log to build a customer viewable error report with the correct hardware/software callout added as applicable. The existence of an error log was signaled to the system controller by the error log id field in a Poll response. With the Get Error Log command, the command type portion identifies the command as a Get Error Log command, and the command data specifies the type of error log response being requested and/or the identity (e.g., log id) of the error log to be returned. In response to the Get Error Log command, a Get Error Log return packet may be generated having the same sequence number and command type values. The Get Error Log return packet may also include a return code in the return status portion to indicate whether the Get Error Log command succeeded. For example, a return code may provide a Conditional Success indication when the user data for a particular error log exceeds a predetermined size limit, thereby indicating that there is more user data for that error log id. In addition, the return data included in the Get Error Log return packet provides data (up to a predetermined size limit) identifying the type and severity of error, as well as user-defined debug data, such as trace data appended to the user data section of the fips error log to aid in debug. With the “Get Error Log” return packet, the length of the return data is limited (e.g., a maximum of 130 bytes), and if additional return data is required, it is sent separately in response to a “Continue Error Log” command.

The “Continue Error Log” command may be used by the system controller to continue reading the user data for an error log. In selected embodiments, this command is only valid when a response status (in the Get Error Log return packet) was received for the error log id indicating that there is more user data for that error log id. With the Continue Error Log command, the command type portion identifies the command as a Continue Error Log command, and the command data identifies the error log to be returned and/or the portion of the error log being returned, such as by using a data block sequence number that may be incremented with each block of data being requested. In response to the Continue Error Log command, a Continue Error Log return packet may be generated having the same sequence number and command type values. The Continue Error Log return packet may also include a return code in the return status portion to indicate whether the Continue Error Log command succeeded. In addition, the return data included in the Continue Error Log return packet provides data (up to a predetermined size limit) identifying the type and severity of error, as well as user-defined debug data. Again, the length of the return data is limited (e.g., a maximum of 130 bytes), and if additional return data is required, it is sent separately in response to a “Continue Error Log” command.

To clear an error log, the system controller can issue a “Clear Error Log” command to acknowledge to the embedded controller that a specified error log has been successfully logged on the system controller. When this command is received, the embedded controller no longer needs to keep the specified error log and can delete it from memory so that the error log id can be used for a new error. However, until the embedded controller receives a Clear Error Log command for a specific error log id, the embedded controller must save that error log. With the Clear Error Log command, the command type portion identifies the command as a Clear Error Log command, and the command data specifies the identity (e.g., log id) of the error log to be cleared. In response to the Clear Error Log command, a Clear Error Log return packet may be generated having the same sequence number and command type values. The Clear Error Log return packet may also include a return code in the return status portion to indicate whether the Clear Error Log command succeeded. With this command. With the Clear Error Log return packet, there is no need for any return data.

The “Set Mode and State” command may be used by the system controller to set the embedded controller state and/or system power management mode. In selected embodiments, this state and system power management mode are sent in this command, the embedded controller inspects the command to determine which one (or both) is being changed, though the embedded controller must support both the embedded controller state and system power management mode being changed with the Set Mode and State command. With the Set Mode and State command, the command type portion identifies the command as a Set Mode and State command, and the command data identifies the embedded controller state (e.g., using state codes identifying the desired state) and the system power management mode (e.g., using power management mode codes identifying the desired mode). In response to the Set Mode and State command, a Set Mode and State return packet may be generated having the same sequence number and command type values. The Set Mode and State return packet may also include a return code in the return status portion to indicate whether the Set Mode and State command succeeded. With the Set Mode and State return packet, there is no need for any return data.

Yet another example command is the “Setup Configuration Data” command which may be used by the system controller to send configuration data that is needed by the embedded controller. With the Setup Configuration Data command, the command type portion identifies the command as a Setup Configuration Data command. In addition, the command data included in the Setup Configuration Data command packet provides data (up to a predetermined size limit) identifying the format for the following command data, thereby specifying the type of configuration data. For example, one format type indicates that the configuration data is for identifying the active processor cores. Another format type indicates that the configuration data will specify an oscillator value, a power cap value, a setpoint value, a critical or warning temperature value, for example. In response to the Setup Configuration Data command, a Setup Configuration Data return packet may be generated having the same sequence number and command type values. The Setup Configuration Data return packet may also include a return code in the return status portion to indicate whether the Setup Configuration Data command succeeded. With the Setup Configuration Data return packet, there is no need for any return data.

The system controller may also issue a “Download Data” command to download data to the embedded controller. In selected embodiments, the Download Data command may be supported by the boot loader and boot code so that the command is only valid when the embedded controller is in a “download” state and the embedded controller's poll response indicates “download ready.” With the Download Data command, the command type portion identifies the command as a Download Data command. In addition, the command data included in the Download Data command packet provides data (up to a predetermined size limit) contains the download data, and may include a block sequence number that may be incremented with each block of data being downloaded. The size limit on downloading data may be increased when the download operations are confined to the boot loader and boot code. In response to the Download Data command, a Download Data return packet may be generated having the same sequence number and command type values. The Download Data return packet may also include a return code in the return status portion to indicate whether the Download Data command succeeded. With the Download Data return packet, there is no need for any return data.

With a “Pass Through” command, the system controller sends a command from an upper layer to the embedded controller. With the Pass Through command, the command type portion identifies the command as a Pass Through command, while the command data provides the command being passed through (up to a predetermined size limit). In response to the Pass Through command, a Pass Through return packet may be generated having the same sequence number and command type values. The Pass Through return packet may also include a return code in the return status portion to indicate whether the Pass Through command succeeded. In addition, the Download Data return packet may include return data in response to the upper layer command.

Yet another command (and associated return) is the “Debug Pass Through” command which is issued by the system controller for use in performing debug operations at the embedded controller. The system controller may also issue an “Interface Test” command (to test the I²C interface to the sensor/regulators), a “Processor Interface Test” command (to test the I²C interface to the processors) and a “Set Clock Frequency” command (to set the embedded controller clock to a specified frequency). Following the same formatting conventions, each of these commands includes a command type portion identifying the command, along with command data appropriate to the corresponding command (up to a predetermined size limit). In response to the commands, a return packet is generated having the same sequence number and command type values. Each return packet may also include a return code in the return status portion to indicate whether the command succeeded. In addition, the return packet may include appropriate return data. For example, in the Interface Test return packet, the return data may include a test result (e.g., success or failure), along with an error log id of any error created by the embedded controller during the test. In the Processor Interface Test return packet, the return data may include a processor interface test result (e.g., success or failure), along with an error log id of any error created by the embedded controller during the test. And in the Set Clock Frequency return packet, the return data may include an indication of whether the clock frequency was set (e.g., success or failure), along with an error log id of any error created by the embedded controller while setting the clock frequency.

In accordance with various embodiments of the present invention, whenever the embedded controller returns a “non-successful” return code, the return packet may be formatted as a series of bytes or portions to include a sequence number portion (which is the same as the sequence number for the corresponding command), a command type portion (to identify the type of command the return packet is for), a return status portion (to provide an indication of the failure), a data length portion, a return data portion (identifying the error log that was created for the command failure), and a checksum portion (for performing error detection on the return packet). In the return data portion, the embedded controller returns the error log id of the error log that it created for this failure. A predetermined error log id (e.g., 0x00) can be used to indicate that there is no error log if the embedded controller does not want to generate an error log for any reason. In response, the system controller will create a fips error log and put the error log id in it to allow correlation with the embedded controller command failure error log for debug. The error log created by the system controller is for the error on what was trying to be accomplished by the command (e.g., a failure to change mode with a “Set Mode and State” command). The embedded controller error log for the command failure will be reported via the same path as all other embedded controller detected errors. In particular, when the error log id is included in response to a Poll command, the system controller sends a “Get Error Log” command to retrieve and log the error on the system controller. And whenever the system controller logs any embedded controller error, it will put the error log id in the fips error log, thereby allowing for correlation.

In an example implementation, the system controller communicates over an I²C bus with an embedded controller to implement a thermal and power management for a base server system, such as a eClipz P6 Blade server system that includes, for example, two or more dual-core P6 modules and a system memory consisting of four or more dual in-line memory modules. Control firmware running on the embedded controller is used to measure and control the power and thermals of system. As the standby power comes on to the base server system, the system controller initiates communication with the embedded controller via a Poll command (described hereinbelow). Through a user interface provided on the system controller or at a higher lever, a customer can input power cap limits and/or thermal requirements. These inputs are sent to the system controller, which then sends these commands over the I²C bus to the embedded controller using the I²C bus interface and protocol described herein. The command is processed by the embedded controller and the response is sent back over the I²C bus using the described interface and protocol to the system controller, where the response is then back up the user interface.

Any data that is required by the embedded controller is formatted by the system controller as a Setup Configuration Data command and then sent to the embedded controller. As this data arrives, it is processed and the embedded controller then updates the Poll response to reflect which new states, if any, it is capable of entering due to the new data. The GPIO attention may also be utilized to accelerate data requests. After a piece of data has been successfully provided to the embedded controller, the embedded controller will immediately assert the GPIO so the next required piece of data (or ready bit in the poll response) can be communicated to the system controller. Eventually, all data that is required to enter the active state arrives, and the embedded controller indicates that it is capable of entering the active state by setting the ready bits within the Poll response. In response, the system controller instructs the embedded controller to enter the active state by sending the Set Mode and State command, and the embedded controller then begins actively controlling the thermal and power characteristics of the system and reports any errors or issues via the Poll response/Get Error Log commands.

Where the communication interface is an I²C bus, the system controller is configured to be the master in regards to communications so that only the system controller sends I²C commands to the embedded controller. However, with conventional I²C bus communications, a NACK address problem can arise when an I²C slave device is not ready to respond to a read request from an I²C master device. To address this, the embedded controller may be configured so that it will always acknowledge an I²C read request to the embedded controller. Once the address for the I²C slave device is ACK'd, the embedded controller holds the clock line until it is ready to send data. And to prevent the embedded controller from holding the line for too long, the system controller uses a timeout interval value.

Based on the foregoing, any I²C error on the system controller side will always result in the system controller doing a read on the I²C bus. For example, if the system controller was performing a write to an embedded controller and only part of the message made it, then the embedded controller will recognize a CRC failure and respond to the system controller read with an error packet. Alternatively, if the system controller was performing a write to the embedded controller and none of it was received, then the embedded controller could potentially go into a receive operation after the timeout, in which case the read from the system controller would not result in any data being sent by the embedded controller. The system controller would treat this as an error and reset the embedded controller, resulting in a resynchronization between system controller and embedded controller. If the system controller was performing a read operation to the embedded controller and received an I²C error, then the system controller will retry the read, expecting the data it was looking for in the first read. The embedded controller is responsible for buffering system controller read commands with a queue when the system controller requests more data then is contained within the return packet from embedded controller. The embedded controller will have a predetermined timeout period (e.g., 10 seconds) when performing I²C writes to the system controller, and if the timeout occurs, the embedded controller will log an informational error and go back to waiting for a write from the system controller.

As will be appreciated by one skilled in the art, the present invention has been described in the context of an exemplary fully functioning data processing system, but may be embodied in whole or in part as a method, system, or computer program product. Furthermore, the present invention may take the form of a computer program product or instructions on a computer readable medium having computer-usable program code embodied in the medium. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system. In addition, the present invention may take the form of an entirely software embodiment (including firmware, resident software, micro-code, etc.), an entirely hardware embodiment, or an embodiment combining software and hardware aspects that may all generally be referred to herein as a “circuit,” “module” or “system.” For example, the interface control functions may be implemented in software instructions or program code stored in the data processing system.

The foregoing description has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification and example implementations provide a complete description of the manufacture and use of the composition of the invention. Since many embodiments of the invention can be made without departing from the spirit and scope of the invention, the invention resides in the claims hereinafter appended.

What is claimed is:

1. A method for controlling communications between a master station controller and one or more slave station controllers, each of which is connected to the master station controller with an I²C bus and a separate communication line, comprising:
sending a command from a master station controller over the I²C bus to a slave station controller by performing in sequence an I²C write operation and an I²C read operation to the slave station controller;
receiving within a first timeout interval a response to the command over the I²C bus from the slave station controller after the slave station controller processes the command;
resending the command from the master station controller over the I²C bus to the slave station controller if a response is not received at the master station controller within the first timeout interval; and
receiving within a second timeout interval a response to the command that was resent by the master station controller, or else logging an error if no response to the command is received within the second timeout interval.

2. The method of claim 1, further comprising:
receiving a communication request from a slave station controller at a master station controller when the separate communication line between the master station controller and a slave station controller is asserted; and
responding to the communication request by sending a status request command from the master station controller over the I²C bus to the slave station controller by performing in sequence an I²C write operation and an I²C read operation to the slave station controller.

3. The method of claim 2, further comprising:
receiving within the first timeout interval a response to the status request command over the I²C bus from the slave station controller after the slave station controller processes the status request command; and
receiving a reset request from a slave station controller at a master station controller when the separate communication line between the master station controller and a slave station controller is cleared.

4. The method of claim 1, where sending a command comprises sending a status request command to obtain status information from the slave station controller.

5. The method of claim 1, where sending a command comprises sending an error log command to obtain or clear an error log from the slave station controller.

6. The method of claim 1, where sending a command comprises sending a set command to set a state or power management mode for the slave station controller.

7. The method of claim 1, where sending a command comprises sending a setup command to configure one or more sensors or regulators that are controlled by the slave station controller.

8. The method of claim 1, where sending a command comprises sending a data download command to download data to the slave station controller.

9. The method of claim 1, where sending a command comprises sending an interface test command for testing an interface to one or more sensors or regulators that are controlled by the slave station controller.

10. The method of claim 1, where sending a command comprises generating a command packet comprising a sequence number field, a command type field, a data length field, a command data field and an error correction field.

11. The method of claim 1, where sending a command comprises sending a plurality of commands from a master station controller over the I²C bus to a slave station controller when a response from the slave station controller indicates that the response exceeds a predetermined size limit.

12. A computer-usable medium embodying computer program code, the computer program code comprising computer executable instructions configured for controlling communications between a master station controller and one or more slave station controllers, each of which is connected to the master station controller with an I²C bus and a separate communication line, by:
sending a command from a master station controller over the I²C bus to a slave station controller by performing in sequence an I²C write operation and an I²C read operation to the slave station controller;
receiving within a first timeout interval a response to the command over the I²C bus from the slave station controller after the slave station controller processes the command;
resending the command from the master station controller over the I²C bus to the slave station controller if a response is not received at the master station controller within the first timeout interval; and
receiving within a second timeout interval a response to the command that was resent by the master station controller, or else logging an error if no response to the command is received within the second timeout interval.

13. The computer-usable medium of claim 12, wherein the embodied computer program code further comprises computer executable instructions configured for:
receiving a communication request from a slave station controller at a master station controller when the separate communication line between the master station controller and a slave station controller is asserted; and
responding to the communication request by sending a status request command from the master station controller over the I²C bus to the slave station controller by performing in sequence an I²C write operation and an I²C read operation to the slave station controller.

14. The computer-usable medium of claim 13, wherein the embodied computer program code further comprises computer executable instructions configured for:
receiving within the first timeout interval a response to the status request command over the I²C bus from the slave station controller after the slave station controller processes the status request command; and
receiving a reset request from a slave station controller at a master station controller when the separate communication line between the master station controller and a slave station controller is cleared.

15. The computer-usable medium of claim 12, where sending a command comprises:
sending a status request command to obtain status information from the slave station controller, or
sending an error log command to obtain or clear an error log from the slave station controller, or
sending a set command to set a state or power management mode for the slave station controller, or
sending a setup command to configure one or more sensors or regulators that are controlled by the slave station controller, or
sending a data download command to download data to the slave station controller, or
sending an interface test command for testing an interface to one or more sensors or regulators that are controlled by the slave station controller, or
generating a command packet comprising a sequence number field, a command type field, a data length field, a command data field and an error correction field, or
sending a plurality of commands from a master station controller over the I²C bus to a slave station controller when a response from the slave station controller indicates that the response exceeds a predetermined size limit.

16. A data processing system comprising:
a processor;
a data bus coupled to the processor; and
a computer-usable medium embodying computer program code, the computer-usable medium being coupled to the data bus, the computer program code comprising instructions executable by the processor and configured for controlling communications between a master station controller and one or more slave station controllers, each of which is connected to the master station controller with an I²C bus and a separate communication line, by:
sending a command from a master station controller over the I²C bus to a slave station controller by performing in sequence an I²C write operation and an I²C read operation to the slave station controller;
receiving within a first timeout interval a response to the command over the I²C bus from the slave station controller after the slave station controller processes the command;
resending the command from the master station controller over the I²C bus to the slave station controller if a response is not received at the master station controller within the first timeout interval; and
receiving within a second timeout interval a response to the command that was resent by the master station controller, or else logging an error if no response to the command is received within the second timeout interval.

17. The data processing system of claim 16, the computer program code further comprising instructions executable by the processor and configured for controlling communications between a master station controller and one or more slave station controllers by:
receiving a communication request from a slave station controller at a master station controller when the separate communication line between the master station controller and a slave station controller is asserted; and
responding to the communication request by sending a status request command from the master station controller over the I²C bus to the slave station controller by performing in sequence an I²C write operation and an I²C read operation to the slave station controller.

18. The data processing system of claim 17, the computer program code further comprising instructions executable by the processor and configured for controlling communications between a master station controller and one or more slave station controllers by:
receiving within the first timeout interval a response to the status request command over the I²C bus from the slave station controller after the slave station controller processes the status request command; and
receiving a reset request from a slave station controller at a master station controller when the separate communication line between the master station controller and a slave station controller is cleared.

19. The data processing system of claim 16, where sending a command comprises:
sending a status request command to obtain status information from the slave station controller, or
sending an error log command to obtain or clear an error log from the slave station controller, or
sending a set command to set a state or power management mode for the slave station controller, or
sending a setup command to configure one or more sensors or regulators that are controlled by the slave station controller, or
sending a data download command to download data to the slave station controller, or
sending an interface test command for testing an interface to one or more sensors or regulators that are controlled by the slave station controller, or
generating a command packet comprising a sequence number field, a command type field, a data length field, a command data field and an error correction field, or
sending a plurality of commands from a master station controller over the I²C bus to a slave station controller when a response from the slave station controller indicates that the response exceeds a predetermined size limit.

20. The data processing system of claim 16, where the separate communication line comprises a GPIO pin which is used to connect the master station controller to a slave station controller.
